(19) United States
(12) Patent Application Publication
(10) Pub. No.: US 2011/0277703 A1
(43) Pub. Date: Nov. 17, 2011

(54) Coat for hunting dogs

(76) Inventor: Keith Yeaw, Foster, RI (US)

(21) Appl. No.: 13/068,306

(22) Filed: May 9, 2011

Related U.S. Application Data
(60) Provisional application No. 61/395,005, filed on May 7, 2010.

(51) Int. Cl. A01K 13/00

(52) U.S. Cl. 119/850

(57) ABSTRACT

A coat for hunting dogs comprises a cape member fitting over the dog, defining a neck opening and having cooperating edges secured to one another by fasteners, preferably magnetic, allowing the dog to free itself from the coat on command. The coat is secured to a fixed member, such as a boat or the ground, whereby it is retained in position after the dog frees itself.

### CROSS-REFERENCE TO RELATED APPLICATION

This application claims priority from United States Provisional Patent Application Serial Number 61/395,005, filed May 7, 2010.

### FIELD OF THE INVENTION

This invention relates to a protective coat for hunting dogs, which can be quickly shed by the dog in order to retrieve a downed waterfowl or the like.

### BACKGROUND OF THE INVENTION

In hunting waterfowl over water, whether from a boat or from land, the typical practice is for the hunter to shoot a flying waterfowl, and when the waterfowl falls into the water, give the “Retrieve” or “Fetch” command to a trained hunting dog. The dog will have been trained to watch for splashes in the water and to leap into the water in the direction of the splash, retrieve the waterfowl, and return to the hunter.

It would be desirable to provide a warm, water-impervious coat to protect and warm the dog between retrieves, as such hunting is often conducted in cold weather, and the wet dog can catch a chill if unprotected from cold air, especially when it is windy. Dog coats per se are well known, of course, as discussed in detail below. However, the coats and similar dog garments that are available and shown in the known prior art are not suited for the purpose of protecting hunting dogs. As detailed below, prior art dog garments are essentially simply rain coats. Flotation devices intended to be worn by the dog while swimming are also known, but these interfere with its freedom of motion, and would not provide warmth and shelter. In either case the garment is intended to remain on the dog until removed by the owner.

If the conventional dog coats shown by the known prior art were used for protection of a hunting dog, the necessity that the usual dog garment be removed by the owner prior to the dog's swimming after a downed waterfowl would impose a delay in the process. This delay might well cause the dog to lose track of the direction of the splash and fail to retrieve the waterfowl. Ideally, the dog would leap into the water essentially immediately after the waterfowl is downed and the “Retrieve” command given. This is not possible if the owner has first to remove the garment.

Generally similar concerns arise in connection with hunting over land, and the coat of the invention is applicable thereto as well.

### SUMMARY OF THE INVENTION

What is desired and provided according to the present invention is a dog coat that can be immediately shed by the dog upon the “Retrieve” command and which will remain behind, so that it can be used to again protect the dog after the retrieve is complete, without undue complexity. This is accomplished according to the invention by provision of a dog coat that is essentially cape-shaped, with pairs of mutually-attracting magnets on opposed edges securing the edges together, thus holding the coat on the dog. The opposed edges are preferably disposed to the front of the dog. A gripping handle is provided, disposed over the dog's shoulders, for the hunter to grasp prior to giving the “Retrieve” command. The coat is also provided with a D-shaped ring or similar securing member whereby the coat can be affixed to a boat, secured to a stake in the ground, tied to a tree, or the like. Thus, when the “Retrieve” command is given, the dog simply leaps forward, parting the seam formed by the magnets, while the coat remains behind for subsequent use. The prior art known does not provide this, as detailed further below.

The coat may also be provided with means for securing camouflage materials, such as reeds, grass or weeds to the coat, to camouflage the presence of the dog. This can be accomplished simply by sewing one or more lengths of webbing or the like around the coat in such a way that loops are provided at intervals into which such camouflage materials can be inserted.

### PRIOR ART

The following US patents and applications were located in a patentability search of the invention:

Curtis U.S. Pat. No. 5,060,458 shows a dog coat to be secured by hook-and-loop material. The invention seems to be in making a one-size-fits—all coat.

La Belle U.S. Pat. No. 6,089,194 shows a reversible dog coat that can be used to warm or cool the dog. It is again fastened with hook-and-loop material.

Brezinski U.S. Pat. No. 6,584,939 shows a dog coat where the invention lies in the strap design. Hook-and-loop material is again suggested for fastening, but magnets are mentioned as an alternative; see col. 4, line 55. Reissue patent RE39,564 is similar.

Sporn patent application Ser. No. 09/923,930, published as 2003/0029389, shows disposable raingear for dogs. Magnetic fastening is mentioned in paragraph 22.

Leo patent application Ser. No. 10/516,096 (published as 2005/0229869) shows a jacket for small animals with a detachable carrying handle.

Teague patent application Ser. No. 11/050,179 (published as 2006/0169221) shows a cooling blanket for dogs provided with decorative elements.

Shelton patent application Ser. No. 11/348,426 (published as 2007/0193532) shows a dog coat covering most of the dog's body, even its feet. Magnets are suggested as an alternative fastening device at paragraph 21.

Sternlight patent application Ser. No. 12/469,590 (published as 2009/0292343) shows a dog coat with an attachable backpack-like device for various purposes. Magnets are again suggested as an alternative fastening device at paragraph 28.

Finally, Shanley design patent D313,291 shows an allegedly ornamental design for a dog coat.

Thus, as above, it seems clear that the known art is all directed to coats which will stay on the dog until the owner wants to take them off, contrary to the present invention. Moreover, according to the present invention, a retaining device is provided in combination with the magnetic fasteners. The known art does not show this. According to the present invention, the dog can free itself from the coat on command, while the coat remains in a desired position. This invention is unobvious in light of the known art. The provision of means for securing camouflage materials to the coat is also unobvious in light of the known art discussed above.

### BRIEF DESCRIPTION OF THE DRAWINGS

The invention will be better understood if reference is made to the accompanying drawings, in which:

FIG. 1 shows a perspective view of a hunting dog wearing the coat of the invention;

FIG. 2 shows a plan view of the coat laid out on a flat surface, seen from the outside; and

FIG. 3 shows a similar view, seen from the inside.

### DESCRIPTION OF THE PREFERRED EMBODIMENTS

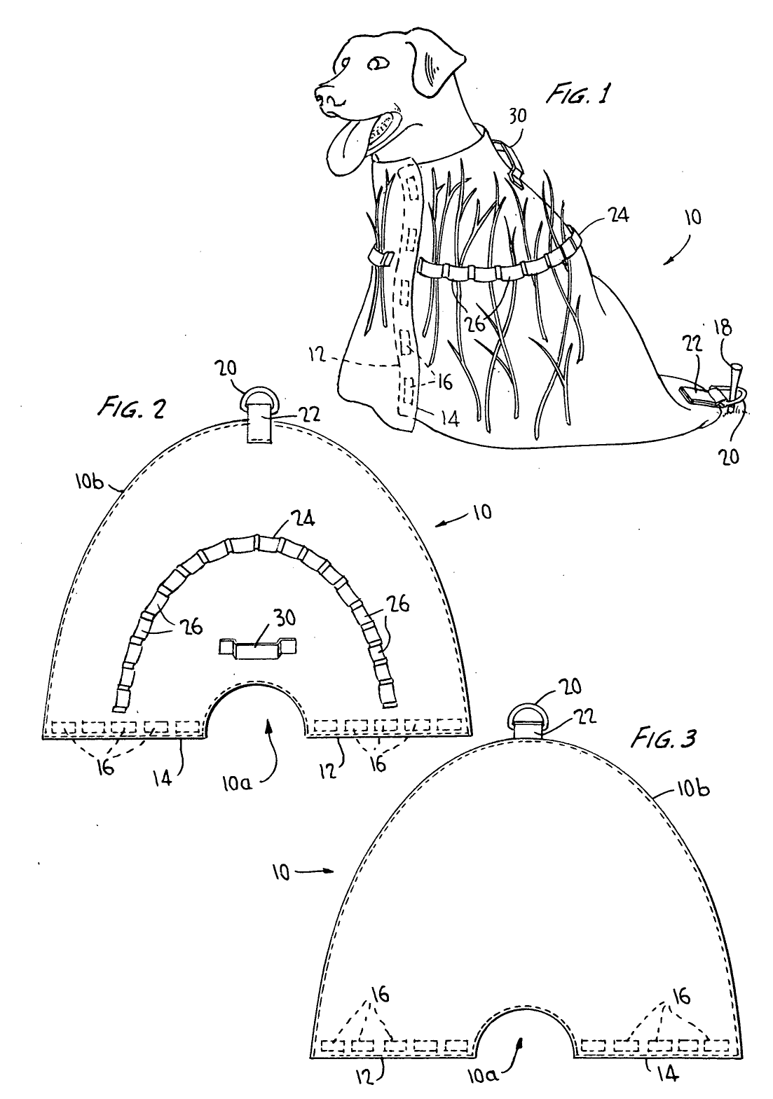

As shown by FIG. 1, when the dog is waiting to respond to the “Retrieve” command, it may be protected from the elements and warmed by wearing the coat 10 of the invention. As shown by each of the Figures, the coat 10 is generally cape-shaped, with a generally semi-circular cut-out 10a for the dog's neck, a generally semi-circular skirt portion lob, and opposed mating edges 12 and 14 extending downwardly from the neck opening when the dog is sitting, as shown. Edges 12 and 14 are secured to one another by pairs of mutually-attracting magnets 16 disposed at corresponding positions along edges 12 and 14, forming a separable seam and holding the coat 10 in place on the dog. Magnets 16 may be provided on both edges 12 and 14, or may be provided on one edge only, with ferromagnetic materials on the other edge, to provide the same function. However, to avoid the weight and possible corrosion problems inherent in use of such materials, ceramic magnets on both edges 12 and 14 are preferred. As illustrated, several pairs of magnets 16 may be disposed along the opposed edges 12 and 14.

Also shown in FIG. 1 is the manner in which the coat 10 may be secured in position, in this case by a stake 18, extending through a D-shaped ring 20 secured to the coat by a strap of webbing or the like 22 that is sewn to the coat 10, and driven into the ground. As above, the coat can also be secured by tying a line from ring 20 to a tree or to a suitable structure on a boat. A gripping strap 30 is also provided, made of webbing sewn to the coat 10.

Thus, when the “Retrieve” command is given, the dog simply lunges forward. The coat is restrained by the D-shaped ring 20, or by the handler's gripping strap 30, so as the dog lunges forward, the seam in the front of the coat 10 formed by the adhesion of the magnets 16 to one another parts, freeing the dog from the coat. When the dog returns, the owner simply drapes the coat over the dog, such that the magnets again are attracted to one another, closing the seam.

Also shown in FIG. 1 is a further improvement. A strip of webbing or the like 24 is sewn around the outer surface of the coat 10, the sewing being performed such that a plurality of small loops 26 are formed between the outer surface of the coat and the inside surface of the webbing 24. Loops 26 can then be filled with reeds, grass, weeds or the like, as shown, so as to camouflage the dog.

FIGS. 2 and 3 illustrate the overall shape of the flat materials from which the coat 10 is made, and illustrate further details of its construction. As illustrated, the coat is preferably made of inner and outer fabric layers sewn together at least around their periphery, and possibly also in a quilted pattern across the surface. Preferably the inner layer is made of wool for warmth, prewashed so as to avoid later shrinkage, and the outer layer of waterproof polyester fabric, typically 600 denier. The magnets 16 may be sewn into pockets between the inner and outer layer, the pockets being formed by stitching around the peripheries of the magnets. As indicated, a D-shaped ring 20, or a similar securing device, can also be secured to the coat 10 by stitching a folded-over strap 22 of webbing to the coat 10, and the camouflage-retaining strip of webbing 24 sewn similarly to the coat 10.

It will be appreciated that the locations of magnets 16 and identification of mating edges 12 and 14 were erroneous in FIGS. 2 and 3 of the parent provisional application, although they were correct in FIG. 1 thereof. This error has been corrected in the drawings of the present complete application.

While a preferred embodiment of the invention has been described, the scope of the invention should not be limited thereto.

More specifically, in the preferred embodiment magnets are employed for securing the opposed edges of the coat 12 and 14 to one another while the dog awaits the “Retrieve” command. It will be apparent that hook-and-loop strip material could possibly be similarly employed. However, magnets are preferred, for the following reasons. Hook-and-loop strip material is best parted by peeling one strip from the other along their length, i.e. by exerting force so as to pull one of the strips away from the other in a direction generally perpendicular to the plane of the conjoined strips. If such strip material is used to secure the opposed edges of the dog coat to one another, and the dog lunges forward in response to the “Retrieve” command, the force exerted on the strips will be in shear, that is, in the plane of the conjoined strips; accordingly, the force will not be optimal and the dog may not be able to escape. Providing a dog coat according to the invention using hook-and-loop material would therefore require careful selection of the amount and location of the hook-and-loop strips. Further, in the field hook-and-loop material will attract burrs and the like. Finally, securing the hook-and-loop strips to one another after each retrieve will require the hunter to carefully align the strips with respect to one another, and press them together. This will be much more difficult than securing the coat fitted with magnetic closures over the dog, which will simply require draping the coat over the dog; in this case the magnets will attract one another and substantially simplify the process.

Nonetheless, there may be demand for dog coats according to the invention that are secured using the hook-and-loop material. Accordingly, while as noted magnets are preferred, the use of hook-and-loop material is nonetheless to be considered within the scope of the invention, except where specifically excluded by the following claims.

I claim:

1. A coat for a hunting dog, comprising:
a cape member formed of at least one fabric material and shaped to define a neck opening for the neck of a dog, and a body-covering portion, said body-covering portion defining cooperating edges mating extending downwardly from said neck opening when the coat is worn by a dog,
said cooperating edges being held to one another to secure the coat over a dog by cooperating fastening members on the cooperating edges, said fastening members being such that the dog can separate the fastening members, separating the cooperating edges, and free itself from the coat on command, and
an anchoring fitting secured to the cape member so that the coat can be secured to a fixed member, whereby the coat is retained in position after the dog frees itself from the coat.

2. The coat of claim 1, wherein said cooperating fastening members are such as to be magnetically attracted to one another.

3. The coat of claim 1, wherein said anchoring fitting is a D-shaped ring secured to the cape member by a strip of webbing sewn to the fabric of the cape member.

4. The coat of claim 1, further comprising one or more members secured to the cape member for receiving and retaining camouflage materials.

5. The coat of claim 4, wherein said one or more members secured to the cape member for receiving and retaining camouflage materials comprise strips of webbing sewn to the cape member so as to define loops for receiving camouflage materials.

6. The coat of claim 1, wherein the fabric of said cape member comprises an inner layer of an insulative material and an outer layer of a water-resistant material.

7. The coat of claim 1, further comprising a gripping strap secured to the outer surface of the coat.
